(19) United States
(12) Patent Application Publication
(10) Pub. No.: US 2004/0183899 A1
(43) Pub. Date: Sep. 23, 2004

(54) Pipe probing apparatus

(75) Inventor: Takeshi Shiota, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/780,693

(22) Filed: Feb. 19, 2004

(30) Foreign Application Priority Data
Mar. 3, 2003 (JP) 2003-55607
Mar. 3, 2003 (JP) 2003-55608

(51) Int. Cl. H04N 7/18; H04N 5/30

(52) U.S. Cl. 348/84; 348/162

(57) ABSTRACT

It is an object of the present invention to provide a pipe probing apparatus comprising a running member which moves forward and backward in a cylindrical pipe while pulling a cable and which includes a camera with a lens, the pipe probing apparatus enabling the position of the camera to be easily adjusted in accordance with the size of the pipe, enabling a hollow located over the pipe to be monitored, and being capable of running smoothly during the forward or backward movement. The present invention provides a pipe probing apparatus comprising a running member which moves forward and backward in a cylindrical pipe and which includes a camera with a lens, the running member being provided with a link mechanism that uses an elevating and lowering adjust means to integrally elevate and lower the camera and a radar device located above the camera. Moreover, the radar device can be independently elevated and lowered.

### FIELD OF THE INVENTION

The present invention relates to an automotive pipe probing apparatus which can use a mounted camera with a lens to probe a pipe for damage or the like while running through the pipe and which can transmit camera information or the like to the ground via a cable for monitoring.

### BACKGROUND OF THE INVENTION

An automotive pipe probing apparatus has hitherto been known which is used to inspect the internal conditions of various pipes and which moves forward and backward through a pipe to probe it for its internal conditions. Such an automative pipe proving apparatus is for example, decribed in the Unexamined Japanese Patent Application Publication (Tokkai-Hei) No.11-64230. Such an automotive pipe probing apparatus has a camera with a fish-eye lens and a lighting device mounted on it. The pipe probing apparatus thus probes a pipe through which it runs, for defects such as damage, by picking up images of the whole pipe while lighting the interior of the pipe. The pipe probing apparatus transmits photographed images to the ground via a cable.

To achieve this, the pipe probing apparatus is configured to locate the camera at the center of the pipe, by adapting a running member for the diameter of the pipe to be probed and selecting a pillar member having a length corresponding to the pipe diameter.

Moreover, the pipe probing apparatus is desired to probe a hollow that may occur over a pipe buried in the ground.

However, it is an object of the pipe probing apparatus described in The Unexamined Japanese Patent Application Publication (Tokkai-Hei) No.11-64230 to provide an inspecting apparatus comprising a running carriage that can be adapted for any pipe regardless of its diameter and a camera always located in a central portion of a line, by allowing the running carriage to expand or contract in the lateral direction of the line in association with its diameter and allowing the camera to move while expanding or contracting in a vertical direction. Accordingly, this pipe probing apparatus requires the running carriage and the position of the camera to be separately adjusted. Furthermore, no considerations are given for, for example, the ability of the inspecting device to run while remaining connected to a cable.

Moreover, no considerations are given for probing of a hollow that may occur over a pipe.

In general, a pipe proving apparatus that probes the interior of a pipe buried in the ground connects to a cable through which the apparatus is supplied with power by a power supply device installed on the ground. The cable is not only used to supply power but also contains signal lines for communicating with a control device and transmitting signals to a monitor. This single relatively thick cable is connected to the running carriage.

Thus, the running carriage moves forward and backward while pulling the thick cable. This hinders the pipe probing apparatus from stable running.

### SUMMARY OF THE INVENTION

It is an object of the present invention to provide a pipe probing apparatus comprising a running member which moves forward and backward in a cylindrical pipe while pulling a cable and which includes a camera with a lens, the pipe probing apparatus enabling the position of the camera to be easily adjusted in accordance with the size of the pipe, enabling a hollow located over the pipe to be monitored, and being capable of running smoothly during the forward or backward movement.

To accomplish this object, an aspect of the present invention set forth in claim 1 provides a pipe probing apparatus comprising a running member which moves forward and backward in a cylindrical pipe while pulling a cable and which includes a camera with a lens, the pipe probing apparatus being characterized in that the running member is provided with a link mechanism that uses an elevating and lowering adjust means to integrally elevate and lower the camera and a radar device located above the camera.

According to the aspect of the present invention set forth in claim 1, configured as described above, even if the size of a pipe to be probed changes, the elevating and lowering adjust means can adjust the expansion and contraction of the link mechanism to set the camera position in accordance with the inner diameter of the pipe.

The pipe probing apparatus according to an aspect of the present invention set forth in claim 2 is characterized by being provided with pivoting arm members that independently elevate and lower the radar device, and in that while the pivoting arm members are kept contracted, the elevating and lowering adjust means simultaneously elevates the camera and the radar device, and when the camera is positioned in a center of a pipe, the radar device has not abutted against an upper inner surface of the pipe yet but is located inside the pipe.

According to the aspect of the present invention set forth in claim 2, configured as described above, the camera position can be adjusted in accordance with the diameter of the pipe regardless of the position of the radar device.

The pipe probing apparatus according to an aspect of the present invention set forth in claim 3 is characterized in that the radar device has a radar box main body and guide rollers each disposed in a front or rear of each of a right and left sides of the box main body, and when the radar device is elevated, the guide rollers first abut against the upper inner surface of the pipe, so that the radar box main body does not abut against the upper inner surface of the pipe.

According to the aspect of the present invention set forth in claim 3, configured as described above, even if the radar box is elevated high enough to come into contact with the upper inner surface of the pipe, it does not abut against the upper inner surface of the pipe.

The pipe probing apparatus according to an aspect of the present invention set forth in claim 4 is characterized in that urging members are disposed on the pivoting arm members to press the radar device against the upper inner surface of the pipe, and is used to always elevate the radar device, and a stopping member is disposed to stop the elevation of the radar device.

According to the aspect of the present invention set forth in claim 4, configured as described above, the radar device can always be positioned at the upper inner surface of the pipe. Accordingly, the pipe probing apparatus can probe a hollow located over the pipe to be probed regardless of its size.

The pipe probing apparatus according to an aspect of the present invention set forth in claim 5 is characterized in that the stopping member is formed by a winding roller rotatively driven by a motor disposed in the radar box main body and a wire which has one end secured to the running member and which is wound around the winding roller, in that winding up the wire lowers the radar device, loosening the wire causes the urging member to elevate the radar device to elevate, and stopping driving of the motor stops the elevating or lowering operation of the radar device.

According to the aspect of the present invention set forth in claim 5, configured as described above, loosening the wire elevates the radar device, and winding up the wire lowers the radar device. Accordingly, the radar device can be elevated and lowered by drivingly controlling the single winding motor.

The pipe probing apparatus according to an aspect of the present invention set forth in claim 6 is characterized in that a video obtained by the camera with the lens can be viewed using a monitor installed on a ground, and the elevation and lowering of the radar device can be controlled from the ground.

According to the aspect of the present invention set forth in claim 6, configured as described above, when an operator finds an obstacle while viewing the interior of the pipe being photographed, the operator can immediately lower the radar device. Consequently, the radar device can be prevented from being damaged.

### BRIEF DESCRIPTION OF THE DRAWINGS

FIG. 1 is a perspective view showing a link mechanism according to the present invention.

FIG. 2 is a side view showing the whole pipe probing apparatus according to the present invention.

FIG. 3 is a front view showing the whole pipe probing apparatus.

FIG. 4 is a perspective view of the pipe probing apparatus in which a link mechanism has been expanded.

FIG. 5 is a perspective view of the pipe probing apparatus in which the link mechanism has been contracted.

FIG. 6 shows a radar device wherein FIG. 6A is a perspective view of the whole radar device and FIG. 6B is a diagram showing that the radar device is located at an upper inner surface of a pipe.

FIG. 7 is a side view of the radar device.

FIG. 8 is a perspective view showing a link mechanism comprising second elevating and lowering adjust means.

FIG. 9 is a schematic diagram showing a first sensing member wherein FIG. 9A shows that a limit switch is inactive and FIG. 9B shows that the limit switch is active.

FIG. 10 is a schematic diagram showing a second sensing member wherein FIG. 10A shows that a limit switch is inactive and FIG. 10B shows that the limit switch is active.

FIG. 11 is a side view of the pipe probing apparatus according to the present invention, showing that the apparatus has been contracted in accordance with a small pipe diameter.

FIG. 12 is a perspective view showing the whole radar device comprising a second upper lever member.

### DETAILED DESCRIPTION OF THE PREFERRED EMBODIMENT

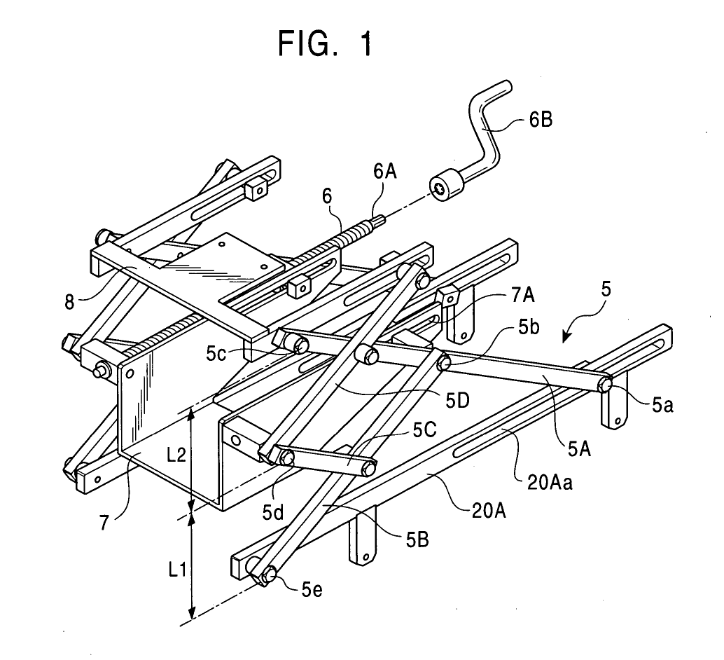

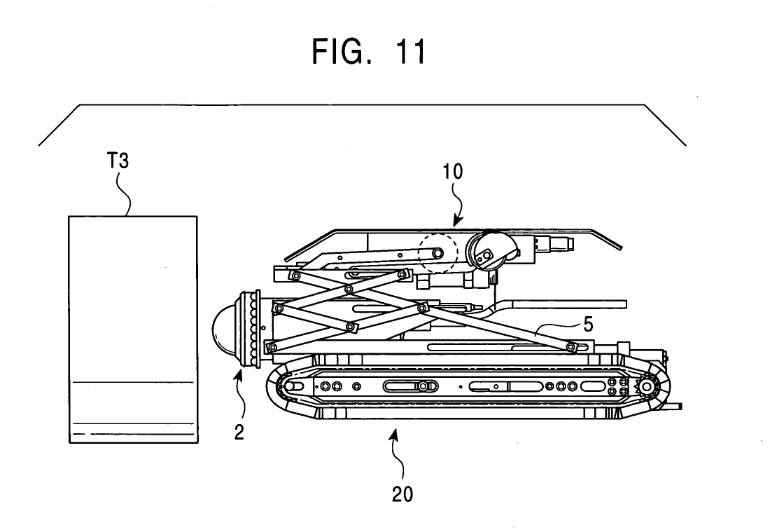

An embodiment of a pipe probing apparatus according to the present invention will, be described with reference to FIGS. 1 to 12.

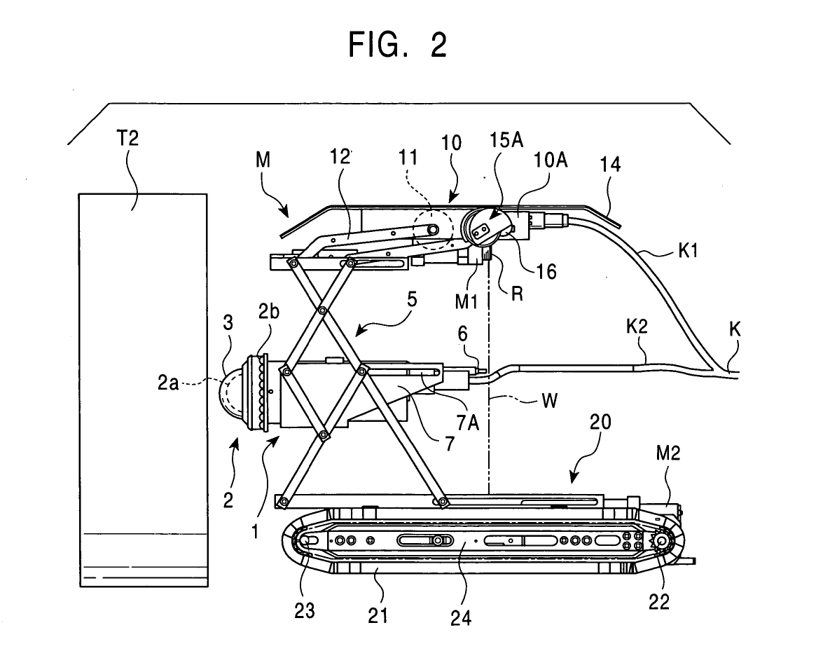

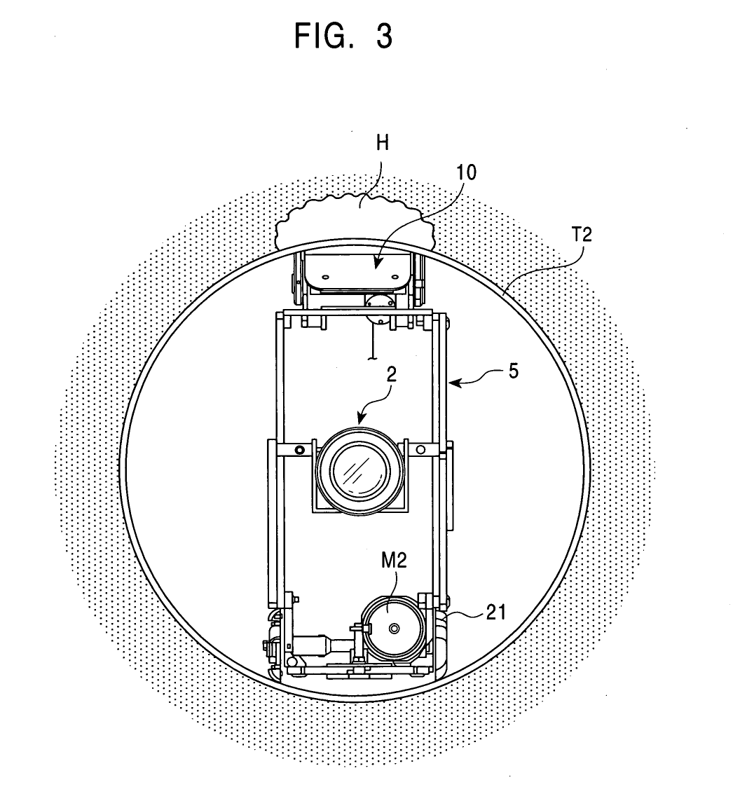

The pipe probing apparatus according to the present invention will be described with reference to FIGS. 2 and 3.

1 is a substantially cylindrical casing, and 2 is a camera disposed at a leading end portion of the casing 1. The camera 2 comprises a fish-eye lens 2a and a plurality of lighting lamps 2b disposed around the lens. A transparent cover 3 is installed so as to cover the fish-eye lens 2a and the lighting lamps 2b.

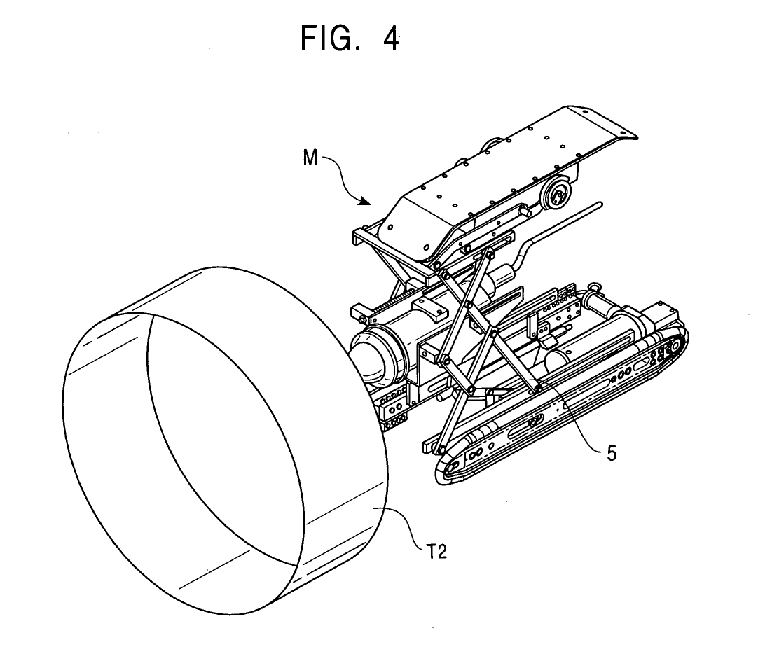

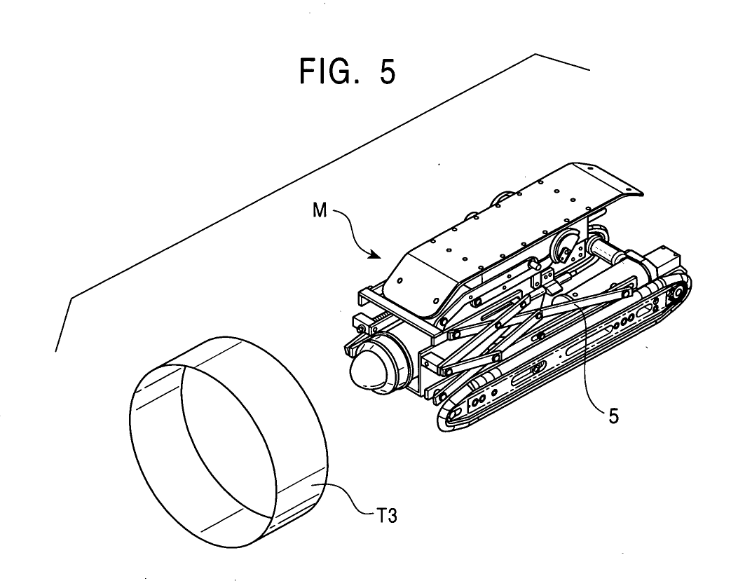

A casing 1 and a radar device 10 are installed on a running member 20 via a link 5 mechanism. When a pipe T2 of a large diameter such as the one shown in FIG. 4 is to be probed, the link 5 is expanded. When a pipe T3 of a small diameter such as the one shown in FIG. 5 is to be probed, the link 5 is contracted. The expansion and contraction of the link 5 is set to be manually executed by rotating a screw rod 6 acting as a first elevating and lowering adjust means. However, the link 5 may be automatically expanded and contracted by installing a separate driving motor to rotate the screw rod 6.

The running member 20 is moved forward and backward by using a running motor M2 to rotate a driving gear 22 and thus a caterpillar 21 extended between the driving gear 22 and a driven gear 23. The driving gear 22, the driven gear 23, and the caterpillar 21 are each disposed on both right and left sides of a frame to integrally constitute the running member 20, shaped like a carriage.

The running member 20, the camera 2, and the radar device 10 are integrally configured via the link mechanism 5 to form a pipe probing apparatus M.

The radar device 10 comprises a radar box main body 10A in which a radar member is accommodated and a total of four guide rollers 11 disposed on the box main body so that each guide roller is located in the front or rear of each of the right and left sides of the box main body.

The pipe probing apparatus M can use the camera 2 with the fish-eye lens 2a to pick up images of the whole of the interior of a pipe through which it runs, while using the lighting lamps 2b to light the interior of the pipe. The pipe probing apparatus M thus probes the pipe for defects such as damage. The pipe probing apparatus M can also probe a hollow portion H located over a pipe T2 buried in the ground. The pipe probing apparatus M is also configured to transmit images obtained by the camera 2, radar signals, and the like to the ground via a cable K.

The camera 2 is configured to photograph the whole inner surface of the pipe using the fish-eye lens 2a. Accordingly, the camera 2 must be located at the central axis of the pipe. To achieve this, the link mechanism 5 is expanded or contracted so as to locate the camera 2 at a position corresponding to the center of the inner diameter of the pipe T2.

The radar device 10 is designed to sit lower than the upper inner surface of the pipe T2 when the link mechanism 5 is operated to set the camera 2 at the central position of the pipe T2 to be probed.

When the link mechanism 5 is expanded or contracted until the camera T2 is located in the center of the pipe T2, the radar device 10 is still away from the upper inner surface of the pipe. Thus subsequently, pivoting arm members 12 are used to elevate the radar device 10.

As shown in FIG. 1, the integral link mechanism 5 is constructed by combining a lower frame 20A with link arms 5A, 5B, 5C, 5D. The screw rod 6, installed on a camera frame 7, is rotated to slide a fulcrum 5b portion along a slot 7A to increase the distance between the fulcrum 5b and a fulcrum 5d. This changes the height positions of the fulcrum 5d and a fulcrum 5c.

Here, a fulcrum 5e is used to attach the link arm 5B to the lower frame 20A and is fixed to the running member 20. The fulcrum 5b connects the link arm 5A and the link arm 5B together, and the fulcrum 5d connects the link arm 5C and the link arm 5D together. Both fulcra 5b, 5d determine the height of the camera frame 7. The fulcrum 5c is an upper end portion of the link frame 5A and determines the height of a radar device frame 8.

In this case, the length of each link arm is set so that the height L1 of the camera frame 7 is larger than a length L2 from the camera frame 7 to the radar device frame 8. Thus, when the center of the camera 2 is aligned with the center of the pipe, the radar device 10 does not abut the upper inner surface of the pipe yet.

To rotate the screw rod 6, it is possible to use a handle member 6B that engages with a rectangular end portion 6A of the screw rod 6. That is, the center of the camera 2 is aligned with the center of the pipe to be probed, in accordance with its diameter. Alternatively, a separate motor may be installed to automatically rotate the screw rod 6.

Furthermore, the screw rod 6 may be installed on the running member 20 in place of the camera frame 7 so that the fulcrum 5a can be moved to expand or contract the link mechanism 5. Thus, the position where the screw rod 6 is disposed is not particularly limited.

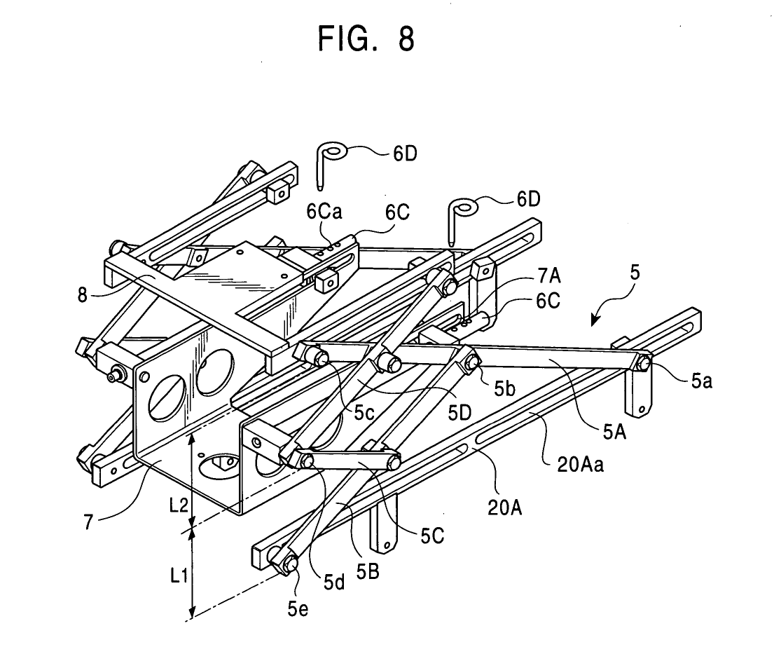

As elevating and lowering adjust means, second elevating and lowering adjust means composed of positioning members 6C and fixing pins 6D may be employed in place of the screw rod 6. In this case, the link mechanism 5 is expanded or contracted to a predetermined height. Then, the fixing pins 6D are inserted into insertion holes 6Ca formed in the positioning members 6C, each disposed on the right or left side of the camera frame 7. The second elevating and lowering adjust means is thus installed to fix the height position of the link mechanism 5. The members shown in FIG. 8 are the same as those described in FIG. 1 and having the same reference numerals. Their detailed description is omitted.

FIG. 4 shows that the pipe probing apparatus M has its height adjusted to probe the pipe T2, which has a large diameter. FIG. 5 shows that the pipe probing apparatus M has its height adjusted to probe a pipe T3 of a small diameter. As is apparent from these figures, simply by expanding or contracting the link mechanism 5 in accordance with the size of the pipe, it is possible to position the camera 2 at the center of the pipe so that the pipe probing apparatus can run automatically through the pipe using the caterpillar 21. In this case, by giving considerations for the length of each of the link frame 5A, 5B, and others, constituting the link mechanism 5, it is possible to adapt the pipe probing apparatus for a wide range of pipe diameters.

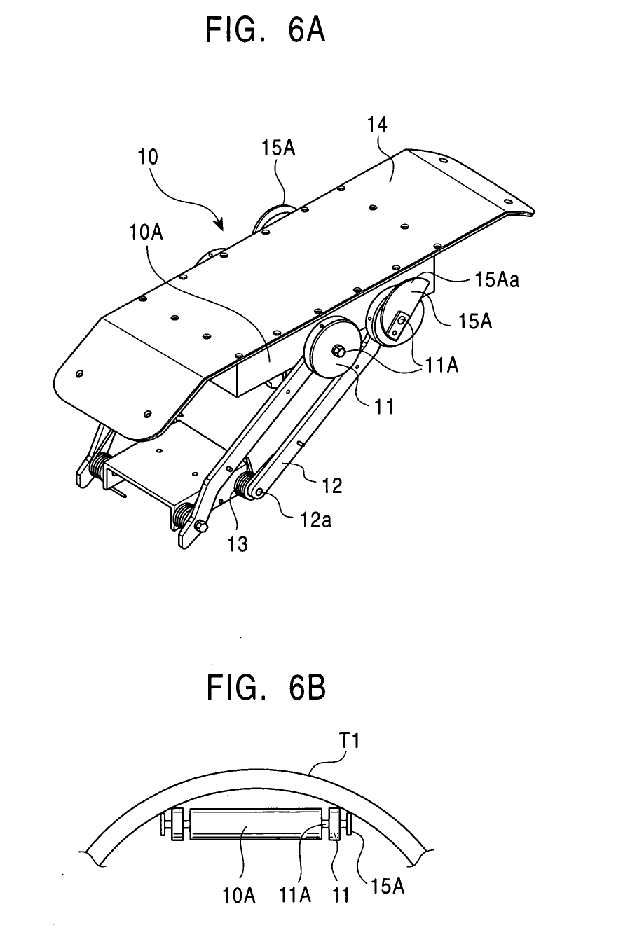

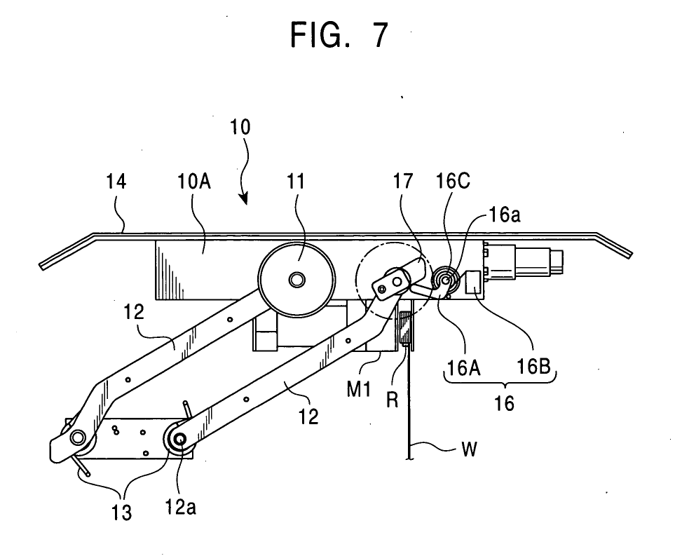

Now, with reference to FIGS. 6 and 7, a description will be given of a mechanism that positions the radar device 10.

To elevate or lower the radar device 10, the pivoting arm members 12 must be moved. Coil springs 13 are installed at all supporting shafts 12a of the total of four pivoting arm members 12, two of which are provided on the right or left side of the apparatus main body. The coil springs 13 thus always urge the radar device 10 in a direction in which it is elevated. One end of a wire W is secured to an arbitrary position of the running member 20. The other end of the wire W is wound around a winding roller R installed on a winding motor M. The radar device 10 can thus be stopped against the urging force of the coil springs 13.

Thus, the stopped radar device 10 is elevated simply by driving the winding motor M1 to rotate the winding roller R to loosen and feed the wire W. Then, the radar device 10 is automatically elevated by the urging force of the coil springs 13.

Now, a description will be given of a process from the start of elevation of the radar device 10 in the pipe until its abutment against the upper inner surface.

When the winding motor M1 is used to loosen the wire W, the radar device 10 is gradually elevated by the urging force of the coil springs 13, installed at the respective supporting shafts 12a of the pivoting arm members 12.

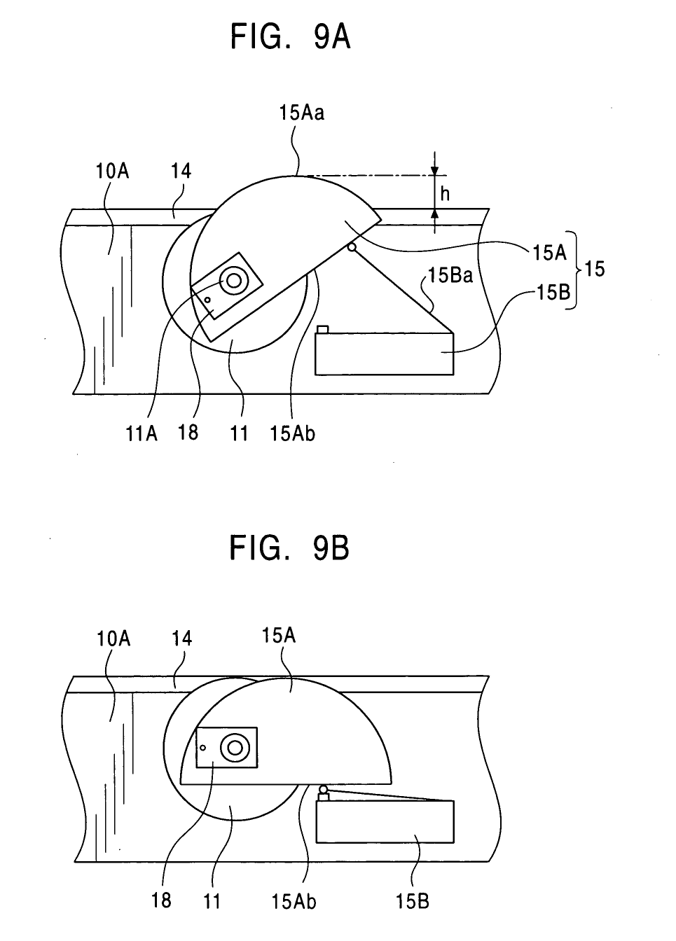

At this time, upper lever members 15A constituting a first sensing member 15 have one end projecting from a top cover 14 of the radar box main body 10A (as shown by h in FIG. 9A) and are elastically supported so as to rotate around a shaft 11A. For limit switches 15B that are members also constituting the first sensing member 15, their sensing lever 15Ba has not be pressed by an upper lever lower part 15Ab yet. Accordingly, the limit switches 15B are open.

When the winding motor M1 is driven to loosen the wire W, the radar device 10 continues to elevate and the end 15Aa of each upper lever member 15A abut against the upper inner surface of pipe. The radar device 10 further continues elevating to rotate the lever member 15A around the shaft 11A in the clockwise direction of the figure. The upper lever lower part 15Ab then presses the sensing lever 15Ba to turn on the limit switch 15B (as shown in FIG. 9B). This signal stops the driving of the winding motor M1. At this time, as shown in FIG. 6B, the guide rollers 11 abut against the upper inner surface of a pipe T1.

In the above description, the limit switches 15B are used to detect movement of the upper lever members 15A. However, the following configuration may also be used. Each upper lever member 15A and the shaft 11A is secured to each other using a fixing member 18. The shaft 11A is installed on the radar box main body via bearings so as to rotate as the upper lever member 15A is rotated. Then, a sensor is provided to sense the movement of the shaft 11A.

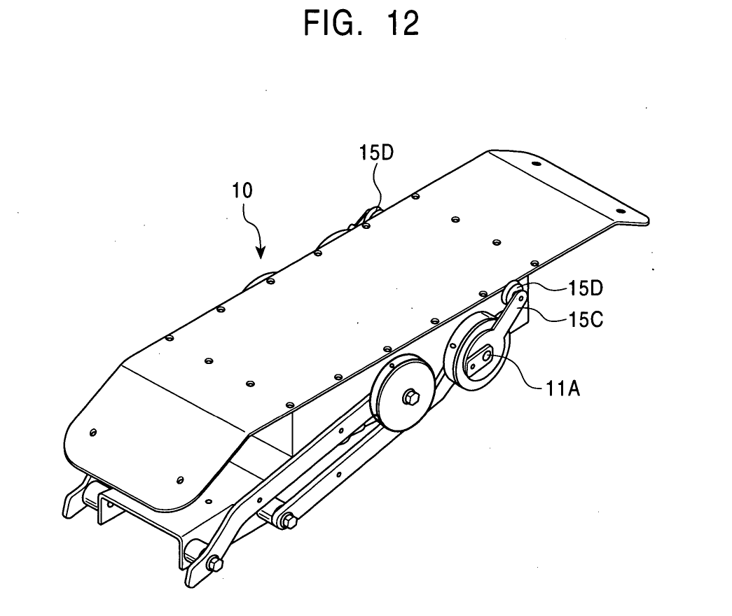

In this case, as shown in FIG. 12, it is possible to employ second upper lever members 15C each comprising a guide roller 15D at its projecting tip portion. This arrangement allows the sensing of the shaft 11A, which moves rotatively with each upper lever member 15C, which moves rotatively when the guide roller 15D abuts against the upper inner surface of the pipe. With this arrangement, the rotating roller section acts as a guide, so that when the radar device 10 elevates, the upper lever members 15C can be rotatively moved stably regardless of the conditions of the inner surface of the pipe.

In short, the apparatus has only to be configured so that the movements of the upper lever members 15A, 15C are sensed so as to stop the driving of the winding motor M1 when the total of four guide rollers 11, each disposed in the front or rear of each side of the radar box main body 10A, abut against the upper inner surface of the pipe T1. To achieve this, it is possible to, for example, preset the size (h) at an appropriate value in accordance with the diameter of the pipe or control the time required to stop the winding motor M1 after sensing the movements of the lever members 15A, 15C. This method is not particularly limited.

As shown in FIG. 6B, when the guide rollers 11 abut against the upper inner surface of the pipe T1, the radar box main body 10A has not abutted against the pipe T1 and is in a non-contact state. Accordingly, the radar box main body 10A does not impose any running loads. This allows the pipe probing apparatus M to run smoothly through the pipe and prevents the radar box main body 10A from being damaged.

Furthermore, the radar device 10 is positioned while the guide roller 11 is in abutment with the upper inner surface of the pipe T1. Consequently, the radar device 10, always separated from a pipe wall by the same distance, probes the hollow portion H, located over the pipe. This leads to accurate probing.

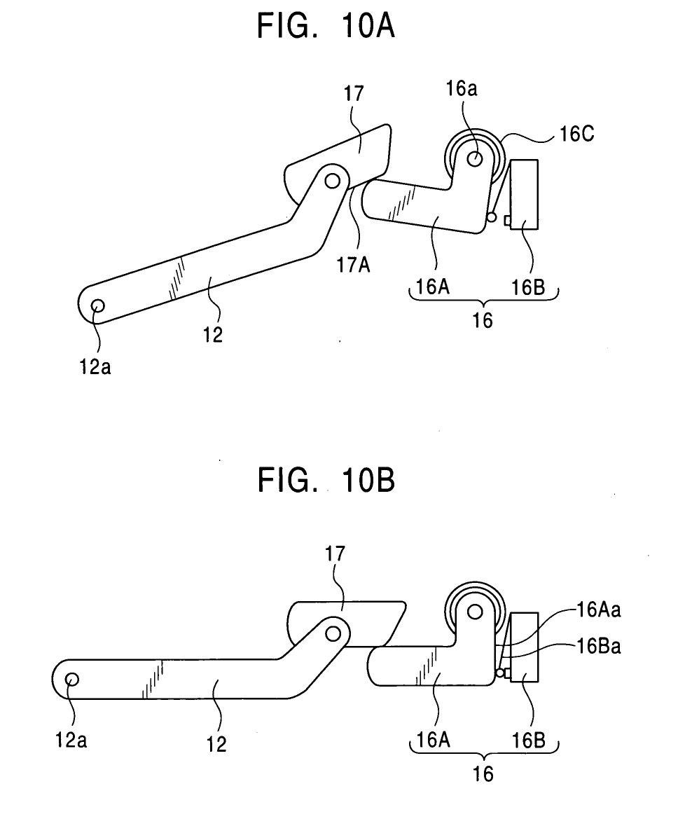

Now, a second sensing member 16 will be described with reference to FIGS. 7 and 10. The second sensing member 16 sets a lowering end for the radar device 10 before it is lowered. The second sensing member 16 is composed of lower-end sensing lever members 16A and limit switches 16B.

When the radar device 10 is lowered, the sensing member 16, composed of the lower-end sensing lever members 16A and limit switches 16B as shown in FIG. 7, detects the lowering end of the radar device 10.

To lower the radar device 10, the winding motor M1 is rotatively driven in a direction in which the wire W is wound around the winding roller R. Then, the tensile tension of the wire W can be utilized to lower the radar device 10 against the urging force of the coil springs 13, which always urge the radar device 10 so that it is elevated.

Once the radar device 10 starts to lower, each pivoting arm member 12 lowers so as to move rotatively around the corresponding shaft 12a in the clockwise direction of the figure. A pressing member 17 is disposed at an upper end portion of each pivoting arm member 12 so as to rotatively move simultaneously with the rotative movement of the pivoting arm 12.

FIG. 10A shows that the radar device 10 has been elevated. FIG. 10B shows that the radar device 10 has been lowered to its lowering end. In this case, when the pivoting arm member 12 is raised (as shown in FIG. 10A), a lower end portion 17A of the pressing member 17 lies at a certain angle from a horizontal state. Accordingly, the lower end portion 17A has not pressed the lower-end sensing lever member 16A yet.

As the radar device 10 is lowered by driving the winding motor M1, the pivoting arm member 12 is gradually inclined to near its horizontal state. At this time, the lower end portion of the pressing member 17 is also inclined to near its horizontal state, thus pressing the lower-end sensing lever member 16A.

Once the lower-end sensing lever member 16A is pressed, an end portion of the lever member 16A presses a sensing lever of the limit switch 16B to turn on the limit switch 16B. This signal stops the driving of the winding motor M1 to stop lowering the radar device 10.

Each lower-end sensing lever member 16A is configured to be urged by the coil spring 16C or the like in a direction in which it abuts against the lower end portion 17A of the corresponding pressing member 17. In the above description, the limit switch 16B senses the movement of the pressing member 17 and thus of the pivoting arm member 12. However, an alternative arrangement may be provided in which the shaft 16a is rotated as the lower-end sensing lever member 16A moves rotatively and which is provided with a sensor sensing the shaft 16a.

As described above, the radar device 10 is elevated and lowered simply by driving the winding motor M1. If the radar device 10 is lowered, the winding motor M1 causes the wire W to be wound to lower the radar device 10, while each sensing member 16, which senses the movement of the corresponding pivoting arm member, senses the lowering end. Then, the rotative driving of the motor M1 is stopped.

Thus, for actual pipe probing, the link mechanism 5 is first expanded or contracted in accordance with the diameter of a pipe to be probed to position the camera 2 at the center of the pipe. Subsequently, the pipe probing apparatus M is inserted into the pipe through a predetermined manhole or the like. The winding motor M1 is driven to elevate the radar device 10 to a position where the guide rollers 11 of the radar device 10 abut against the upper inner surface of the pipe.

In this state, while the pipe probing apparatus M is running forward, the pipe is probed for damage or like using the fish-eye lens 2a and the laser device 10 probes the hollow portion H over the pipe. On this occasion, to allow the pipe probing apparatus M to move forward while drawing a cable K containing a feeding line K1 for dragging the motor and a signal line K2, it is preferable to feed the cable K in unison with the forward movement of the pipe probing apparatus M.

Once the pipe has been probed over a predetermined distance, the pipe probing apparatus M is moved backward and taken out of the manhole. The pipe probing apparatus M is inserted into a next manhole and next pipe probing is then executed. In this case, by moving the pipe probing apparatus M backward with the radar device 10 remaining at the lowering end, it is possible to reduce the running load on the pipe probing apparatus M. The pipe probing apparatus M can thus run backward smoothly.

The backward running may be achieved by rotating the caterpillar 21 in the opposite direction to positively drive the pipe probing apparatus M or forcing the cable K to be unwound to pull out the pipe probing apparatus M. In either way, the pipe probing apparatus M is pulled out with the radar device 10 remaining lowered. Nothing but the caterpillar 21 contacts with the pipe wall, thus allowing the pipe probing apparatus M to run smoothly.

Furthermore, even while the pipe probing apparatus M is moving forward to probe the interior of the pipe, when the presence of an obstacle is found in the pipe using the camera 2, the obstacle can be avoided by controlling the radar device 10 from the ground so that it is lowered.

Consequently, the pipe probing apparatus M can run smoothly during both forward and backward movements.

As described above, according to the present invention, the camera and the radar device can be easily aligned with each other in accordance with the size of the pipe. Accordingly, the same pipe probing apparatus can be used to probe pipes of various sizes.

Furthermore, the radar device, always located at the upper inner surface of the pipe, can probe the hollow located over the pipe.

Moreover, the radar device can be independently elevated and lowered. Accordingly, when the interior of the pipe is probed, the radar device can be elevated to a predetermined position for probing. If any obstacle is found or the pipe probing apparatus is moved backward, the apparatus can run with the radar device remaining lowered. This reduces the running load to allow the pipe probing device to run smoothly. The pipe probing apparatus is thus prevented from being damaged.

1. A pipe probing apparatus comprising a running member which moves forward and backward in a cylindrical pipe while pulling a cable and which includes a camera with a lens, the pipe probing apparatus being characterized in that said running member is provided with a link mechanism that uses an elevating and lowering adjust means to integrally elevate and lower said camera and a radar device located above the camera.

2. A pipe probing apparatus according to claim 1, characterized by being provided with pivoting arm members that independently elevate and lower said radar device, and in that while the pivoting arm members are kept contracted, said elevating and lowering adjust means simultaneously elevates said camera and said radar device, and when said camera is positioned in a center of a pipe, said radar device has not abutted against an upper inner surface of the pipe yet but is located inside said pipe.

3. A pipe probing apparatus according to claim 1 or claim 2, characterized in that said radar device has a radar box main body and guide rollers each disposed in a front or rear of each of a right and left sides of the box main body, and when said radar device is elevated, said guide rollers first abut against the upper inner surface of the pipe, so that said radar box main body does not abut against the upper inner surface of the pipe.

4. A pipe probing apparatus according to any one of claim 1 to claim 3, characterized in that urging members are disposed on said pivoting arm members to press said radar device against the upper inner surface of the pipe, and are used to always elevate said radar device, and a stopping member is disposed to stop the elevation of said radar device.

5. A pipe probing apparatus according to claim 4, characterized in that said stopping member is formed by a winding roller rotatively driven by a motor disposed in the radar box main body and a wire which has one end secured to the running member and which is wound around said winding roller, in that winding up said wire lowers the radar device, loosening said wire causes said urging member to elevate the radar device to elevate, and stopping driving of the motor stops the elevating or lowering operation of said radar device.

6. A pipe probing apparatus according to any one of claims 1 to 5, characterized in that a video obtained by said camera with the lens can be viewed using a monitor installed on a ground, and the elevation and lowering of said radar device can be controlled from the ground.

7. A pipe probing apparatus comprising a running member which moves forward and backward in a cylindrical pipe while pulling a cable and which includes a camera with a lens, the pipe probing apparatus being characterized in that a radar device is disposed above the running member so as to elevate and lower freely via pivoting arm members, and the pipe probing apparatus comprises a first sensing member that senses an elevating end of the radar device and a second sensing member that senses a lowering end of the radar device, and when each of the sensing members senses the corresponding end, elevation or lowering of said radar device is stopped.

8. A pipe probing apparatus according to claim 7, characterized in that said radar device has a radar box main body and guide rollers disposed in a front and rear portions of each of a right and left sides of the box main body, and when said radar device is elevated, said guide rollers first abut against the upper inner surface of the pipe, so that said radar box main body does not abut against the upper inner surface of the pipe.

9. A pipe probing apparatus according to claim 7 or claim 8, characterized in that urging members are disposed on said pivoting arm members to press said radar device against the upper inner surface of the pipe, and are used to always elevate said radar device, and a stopping member is disposed to stop the elevation of said radar device.

10. A pipe probing apparatus according to claim 9, characterized in that said stopping member is formed by a winding roller rotatively driven by a motor disposed in the radar box main body and a wire which has one end secured to the running member and which is wound around said winding roller, in that winding up said wire lowers the radar device, loosening said wire causes said urging member to elevate the radar device, and stopping driving of the motor stops the elevating or lowering operation of said radar device.

11. A pipe probing apparatus according to claim 10, characterized in that said first sensing member comprises upper lever members installed on said guide roller section and limit switches that sense movement of the corresponding lever members, and when said radar device is elevated, said upper lever members first abut against the upper inner surface of the pipe, said guide rollers then abut against the upper inner surface of the pipe, and at the same time, said limit switches are activated to cause said stopping member to stop said radar device.

12. A pipe probing apparatus according to claim 11, characterized in that said second sensing member comprises lower-end sensing lever members installed on said respective pivoting arm members and limit switches that sense movement of the corresponding lever members, and when said radar device is lowered to the lowering end, said lower-end sensing lever members are first moved by said pivoting members to activate said limit switches to cause said stopping member to stop said radar device.

13. A pipe probing apparatus according to any one of claims 7 to 12, characterized in that a video obtained by said camera with the lens can be viewed using a monitor installed on a ground, and the elevation and lowering of said radar device can be controlled from the ground.
